(19) United States
(12) Patent Application Publication
(10) Pub. No.: US 2016/0253497 A1
(43) Pub. Date: Sep. 1, 2016

(54) Return Oriented Programming Attack Detection Via Memory Monitoring

(71) Applicant: QUALCOMM Incorporated, San Diego, CA (US)

(72) Inventors: Mihai Christodorescu, San Jose, CA (US); Charles Bergan, Cardiff, CA (US); Rajarshi Gupta, Sunnyvale, CA (US); Satyajit Prabhakar Patne, San Diego, CA (US); Sumita Rao, San Diego, CA (US)

(21) Appl. No.: 14/632,652

(22) Filed: Feb. 26, 2015

(51) Int. Cl. G06F 21/55; G06F 21/56

(52) U.S. Cl. CPC G06F 21/554; G06F 21/566

(57) ABSTRACT

Aspects include computing devices, systems, and methods for implementing detecting return oriented programming (ROP) attacks on a computing device. A memory traversal map for a program called to run on the computing device may be loaded. A memory access request of the program to a memory of the computing device may be monitored and a memory address of the memory from the memory access request may be retrieved. The retrieved memory address may be compared to the memory traversal map and a determination of whether the memory access request indicates a ROP attack may be made. The memory traversal map may include a next memory address adjacent to a previous memory address in the memory traversal map. A cumulative anomaly score based on mismatches between the retrieved memory address and the memory traversal map may be calculated and used to determine whether to load a finer grain memory traversal map.

### BACKGROUND

Return oriented programming (ROP) attacks are hard to detect efficiently. An ROP attack consists of using a vulnerability in a program to overwrite the control-flow data (e.g., a stack). The result of the attack is that the original code of the program (and its support libraries) is executed in a new, unexpected order. For most programs, the attacker can do anything they wish by changing the order of code execution. No new code is introduced, so standard techniques to detect code-injection do not work for detecting ROP attacks. Current techniques for detecting ROP attacks require either significant changes to software and/or hardware at runtime, or significant changes to the compiler toolchain.

### SUMMARY

The methods and apparatuses of various aspects provide circuits and methods for detecting return oriented programming attacks on a computing device. In various embodiments, the methods may include loading a memory traversal map for a program called to run on the computing device, monitoring a memory access request of the program to a memory of the computing device, comparing a memory address of the memory from the memory access request to the memory traversal map, and determining whether the memory access request indicates a return oriented programming attack based on the comparison of the memory address to the memory traversal map. In various embodiments the memory traversal map may include a plurality of memory addresses for processor-executable codes of the program stored in the memory and the plurality of memory addresses are linked in an order of access of the memory corresponding to an order of execution of the processor-executable codes for the program such that a next memory address of the plurality of memory addresses is adjacent to a previous memory address in the memory traversal map.

In some embodiments loading a memory traversal map for a program running on the computing device may include loading the next memory address based on a previous memory access request for the previous memory address, and comparing a memory address of the memory from the memory access request to the memory traversal map may include comparing the memory address to the next memory address.

In some embodiments comparing a memory address of the memory from the memory access request to the memory traversal map may include determining whether the memory address matches the next memory address, and determining whether the memory access request indicates a return oriented programming attack based on the comparison of the memory address to the memory traversal map may include determining whether the memory access request indicates a return oriented programming attack in response to determining that the memory address does not match the next memory address.

In some embodiments the methods may further include holding a return of the memory access request in response to determining that the memory access request indicates a return oriented programming attack, and releasing the return of the memory access request in response to determining that the memory access request does not indicate a return oriented programming attack.

In some embodiments the methods may further include determining an anomaly score for a mismatch between the memory address of the memory from the memory access request and the memory traversal map, calculating a cumulative anomaly score using the determined anomaly score, comparing the cumulative anomaly score to a cumulative anomaly score threshold, and loading a finer grain memory traversal map in response to the cumulative anomaly score exceeding the cumulative anomaly score threshold.

In some embodiments, loading a memory traversal map for a program called to run on the computing device may include loading a memory traversal map representing a part of the program likely to be affected by a return oriented programming attack.

In some embodiments the methods may further comprising triggering a configurable security response in response to determining that the memory access request indicates a return oriented programming attack.

In some embodiments the memory traversal map may be a virtual memory traversal map created from an interprocedural control flow graph and a virtual memory layout of the program. In some embodiments the memory traversal map may be a physical memory traversal map created from an interprocedural control flow graph, a virtual memory layout of the program, and an operating system virtual-to-physical page map.

### BRIEF DESCRIPTION OF THE DRAWINGS

The accompanying drawings, which are incorporated herein and constitute part of this specification, illustrate example aspects of the invention, and together with the general description given above and the detailed description given below, serve to explain the features of the invention.

FIG. 1 is a component block diagram illustrating a computing device suitable for implementing an aspect.

FIG. 2 is a component block diagram illustrating an example multi-core processor suitable for implementing an aspect.

FIG. 3 is a component block diagram illustrating an example system on chip (SoC) suitable for implementing an aspect.

FIG. 4 is an illustration of an interprocedural control flow graph for a program in accordance with an aspect.

FIG. 5 is an illustration of a memory traversal map for a program in accordance with an aspect.

FIG. 6 is an illustration of memory contents stored in various configurations relative to respective memory regions in a memory in accordance with an aspect.

FIG. 7 is process flow diagram illustrating an aspect method for implementing detection of return oriented programming attacks using memory monitoring.

FIG. 8 is process flow diagram illustrating an aspect method for loading a memory traversal map for a program.

FIG. 9 is process flow diagram illustrating an aspect method for loading memory addresses for memory regions from a memory traversal map for a program.

FIG. 10 is process flow diagram illustrating an aspect method for comparing a memory access sequence of a running program against a memory traversal map for the program.

FIG. 11 is process flow diagram illustrating an aspect method for determining whether a mismatch of a memory address of a memory access request and an expected next memory address of a memory traversal map for a program is Indicative of a return oriented programming attack.

FIG. 12 is component block diagram illustrating an example mobile computing device suitable for use with the various aspects.

FIG. 13 is component block diagram illustrating an example mobile computing device suitable for use with the various aspects.

FIG. 14 is component block diagram illustrating an example server suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The terms “computing device” and “mobile computing device” are used interchangeably herein to refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar personal electronic devices that include a memory, and a multi-core programmable processor. While the various aspects are particularly useful for mobile computing devices, such as smartphones, which have limited memory and battery resources, the aspects are generally useful in any electronic device that implements a plurality of memory devices and a limited power budget in which reducing the power consumption of the processors can extend the battery-operating time of the mobile computing device.

The term “system-on-chip” (SoC) is used herein to refer to a set of interconnected electronic circuits typically, but not exclusively, including a hardware core, a memory, and a communication interface. A hardware core may include a variety of different types of processors, such as a general purpose processor, a central processing unit (CPU), a digital signal processor (DSP), a graphics processing unit (GPU), an accelerated processing unit (APU), an auxiliary processor, a single-core processor, and a multi-core processor. A hardware core may further embody other hardware and hardware combinations, such as a field programmable gate array (FPGA), an application-specific integrated circuit (ASCI), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

Aspects include methods and computing devices implementing such methods for detecting ROP attacks without having to significantly change software and/or hardware at runtime, or the compiler toolchain. Such aspect methods and circuits may monitor memory access for anomalous memory access sequences and determine when such anomalous memory access sequences are likely ROP attacks.

Before an instruction is executed by a processor, it has to be fetched from memory (including multiple cache layers and RAM). ROP attacks result in anomalous execution flows, which induce anomalous memory access sequences. Identifying when anomalous memory access sequences occur and determining whether the anomalous memory access sequences is an ROP attack may allow a computing device to respond to the ROP attack. For any program to be executed on the computing device, an analysis of the program, by static code analysis, dynamic program execution analysis, or a combination thereof, may produce an inter-procedural control flow graph of the instruction execution for the program. The inter-procedural control flow graph may correlate instructions to be executed with other instructions to be executed by the program. This correlation of instructions may be converted to a hardware specific memory traversal map specifying the memory regions expected to be accessed during execution of the program, and the order in which the memory regions should be accessed in relation to access of other memory regions during execution of the program. The memory regions may depend on the memory layout selected by a compiler or linker.

For the program scheduled for execution, the memory traversal map of the program may be loaded to a memory monitoring hardware (sometimes referred to herein as a “stream monitor”). This can be accomplished by loading, for each memory region in the memory traversal map, a code address that indicates an access is implemented for that memory region. In an aspect, a single code address may be sufficient to identify a memory region. In an aspect, multiple code addresses may be needed to identify the memory region, such as for access to different layers of the memory hierarchy or speculation execution of different parts of the program instructions.

During program execution, an access monitor of the stream monitor may monitor the memory access request addresses (virtual or physical). In an aspect, memory access monitoring may be implemented as described in U.S. patent application Ser. No. 14/512,434 filed on Oct. 12, 2014, entitled “Approximation of Execution Events Using Memory Hierarchy Monitoring”, which is hereby incorporated by reference for purposes of details of memory access monitoring. The access monitor may produce a stream of events, such as memory addresses of the memory access requests. An identification component (“identifier”) may compare individual and sequences of memory addresses in the stream of events produced by the access monitor to the memory traversal map, and determine from the comparison whether one or more of the addresses within the stream of memory addresses corresponds to a valid path through the memory traversal map. When a sequence of memory addresses does not correspond to a valid path, this indicates that an invalid the execution of the program is occurring, which may be determined to be an ROP attack.

In an aspect, a single memory address deviation from a valid path may be determined as an ROP attack. In an aspect, the memory traversal map may not be complete or completely accurate. Depending on the confidence of the completeness or accuracy of different portions of the memory traversal map, memory address deviations from the valid paths may be given confidence scores that indicate the likelihood that a deviation is an ROP attack. For lower completeness or accuracy portions of the memory traversal map, a number of memory address deviations may be needed to determine whether the culmination of the memory address deviations indicate an ROP attack.

Programs may be large and complex, leading to large and complex memory traversal maps. To aid in detecting ROP attacks, those parts of the program that are vulnerable or most likely to be affected by an ROP attack (e.g., code that interacts with network inputs, code that invokes system calls, code for financial transaction) may be preselected and memory access monitoring may be focused on the corresponding memory regions.

In an aspect, multiple memory traversal maps of varying degrees of granularity may be generated or provided for a program, in which case a coarse grain memory traversal map may be used initially as screen for violations (e.g., a single memory address off a valid path), and when an anomaly or violation is detected the use of a finer grain memory traversal map may be triggered, and comparisons of memory addresses to the fine grain memory traversal map may be used to identify ROP attacks.

In an aspect, the execution of the analysis of the memory accesses may occur prior to the execution of the corresponding program instructions in order to prevent the execution of an ROP attack. Upon detection of an ROP attack, the program instruction may be prevented from executing. In various aspects, in response to detecting an ROP attack, an alert may be raised, the program may be terminated, the program may be sandboxed, a program state may be repaired, and/or a program state may be rolled back.

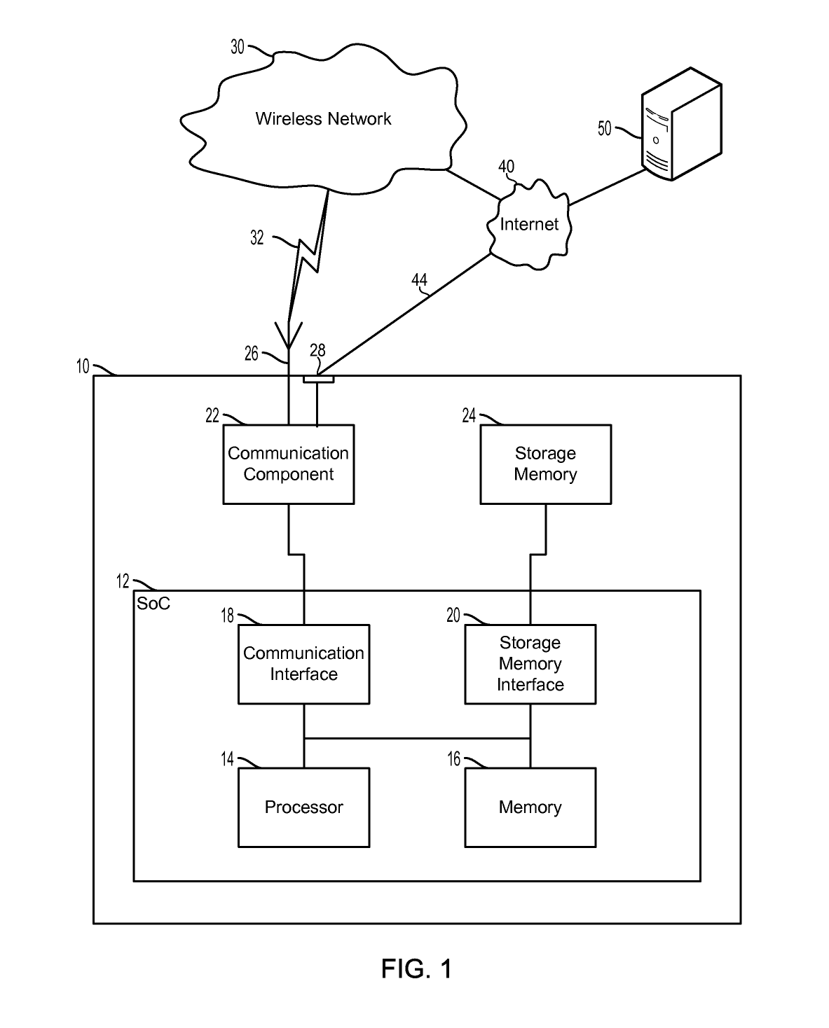

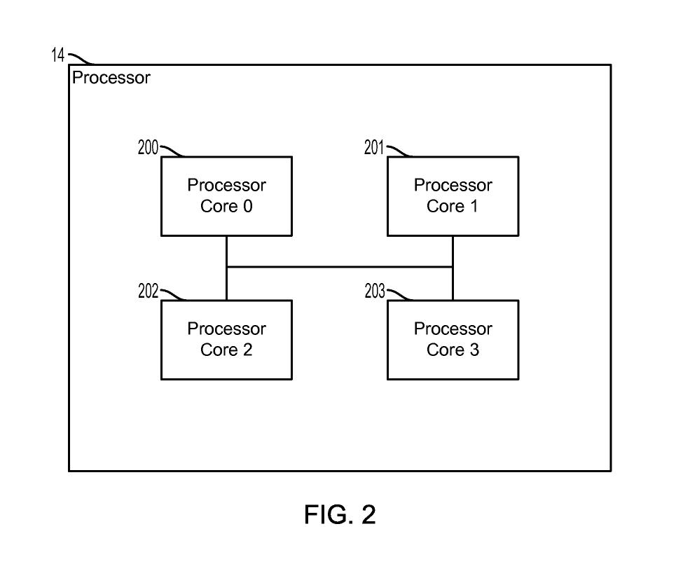

FIG. 1 illustrates a system including a computing device 10 in communication with a remote computing device 50 suitable for use with the various aspects. The computing device 10 may include an SoC 12 with a processor 14, a memory 16, a communication interface 18, and a storage memory interface 20. The computing device may further include a communication component 22 such as a wired or wireless modem, a storage memory 24, an antenna 26 for establishing a wireless connection 32 to a wireless network 30, and/or the network interface 28 for connecting to a wired connection 44 to the Internet 40. The processor 14 may include any of a variety of hardware cores, as well as a number of processor cores. The SoC 12 may include one or more processors 14. The computing device 10 may include more than one SoCs 12, thereby increasing the number of processors 14 and processor cores. The computing device 10 may also include processor 14 that are not associated with an SoC 12. Individual processors 14 may be multi-core processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. In an aspect, one or more memories 16 may include volatile memories such as random access memory (RAM) or main memory, or cache memory. These memories 16 may be configured to temporarily hold a limited amount of data and/or processor-executable code instructions that is requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store processor-executable code, at least temporarily, that is loaded to the memory 16 from another memory device, such as another memory 16 or storage memory 24, for access by one or more of the processors 14. The processor-executable code loaded to the memory 16 may be loaded in response to execution of a function by the processor 14. Loading the processor-executable code to the memory 16 in response to execution of a function may result from a memory access request to the memory 16 that is unsuccessful, or a miss, because the requested processor-executable code is not located in the memory 16. In response to a miss, a memory access request to another memory device may be made to load the requested processor-executable code from the other memory device to the memory device 16. Loading the processor-executable code to the memory 16 in response to execution of a function may result from a memory access request to another memory device, and the processor-executable code may be loaded to the memory 16 for later access.

The communication interface 18, communication component 22, antenna 26, and/or network interface 28, may work in unison to enable the computing device 10 to communicate over a wireless network 30 via a wireless connection 32, and/or a wired network 44 with the remote computing device 50. The wireless network 30 may be implemented using a variety of wireless communication technologies, including, for example, radio frequency spectrum used for wireless communications, to provide the computing device 10 with a connection to the Internet 40 by which it may exchange data with the remote computing device 50.

The storage memory interface 20 and the storage memory 24 may work in unison to allow the computing device 10 to store data and processor-executable code on a non-volatile storage medium. The storage memory 24 may be configured much like an aspect of the memory 16 in which the storage memory 24 may store the processor-executable code for access by one or more of the processors 14. The storage memory 24, being non-volatile, may retain the information even after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be differently arranged and/or combined while still serving the necessary functions. Moreover, the computing device 10 may not be limited to one of each of the components, and multiple instances of each component may be included in various configurations of the computing device 10.

FIG. 2 illustrates a multi-core processor 14 suitable for implementing an aspect. With reference to FIG. 1, the multi-core processor 14 may have a plurality of homogeneous or heterogeneous processor cores 200, 201, 202, 203. The processor cores 200, 201, 202, 203 may be homogeneous in that, the processor cores 200, 201, 202, 203 of a single processor 14 may be configured for the same purpose and have the same or similar performance characteristics. For example, the processor 14 may be a general purpose processor, and the processor cores 200, 201, 202, 203 may be homogeneous general purpose processor cores. Alternatively, the processor 14 may be a graphics processing unit or a digital signal processor, and the processor cores 200, 201, 202, 203 may be homogeneous graphics processor cores or digital signal processor cores, respectively. For ease of reference, the terms “processor” and “processor core” may be used interchangeably herein.

The processor cores 200, 201, 202, 203 may be heterogeneous in that, the processor cores 200, 201, 202, 203 of a single processor 14 may be configured for different purposes and/or have different performance characteristics. Example of such heterogeneous processor cores may include what are known as “big.LITTLE” architectures in which slower, low-power processor cores may be coupled with more powerful and power-hungry processor cores.

In the example illustrated in FIG. 2, the multi-core processor 14 includes four processor cores 200, 201, 202, 203 (i.e., processor core 0, processor core 1, processor core 2, and processor core 3). For ease of explanation, the examples herein may refer to the four processor cores 200, 201, 202, 203 illustrated in FIG. 2. However, the four processor cores 200, 201, 202, 203 illustrated in FIG. 2 and described herein are merely provided as an example and in no way are meant to limit the various aspects to a four-core processor system. The computing device 10, the SoC 12, or the multi-core processor 14 may individually or in combination include fewer or more than the four processor cores 200, 201, 202, 203 illustrated and described herein.

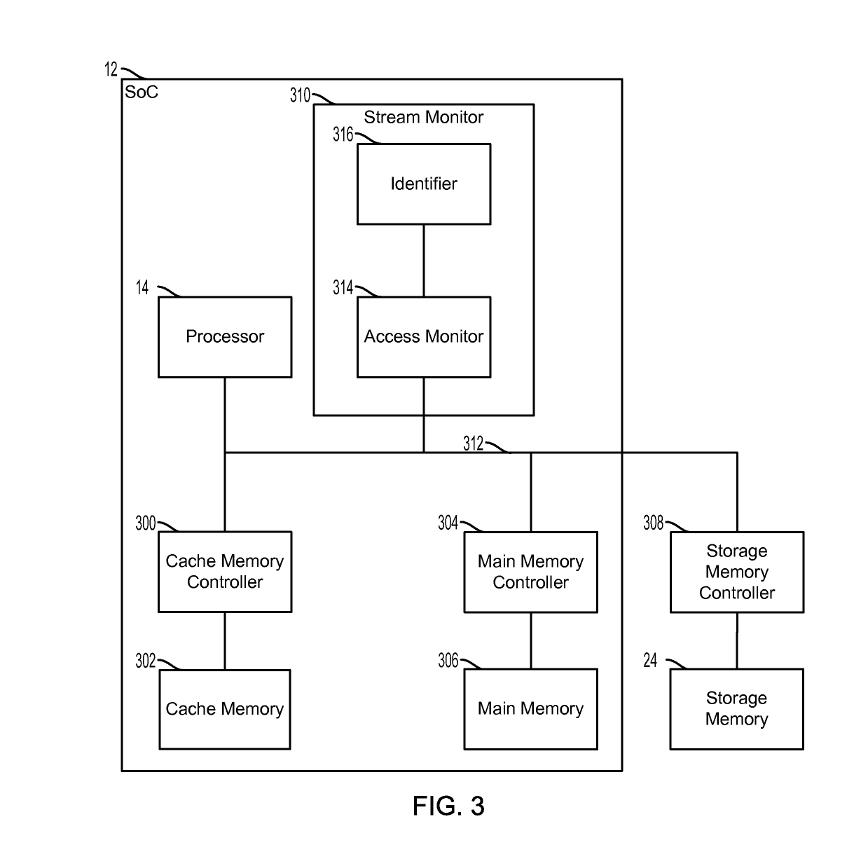

FIG. 3 illustrates an example SoC 12 suitable for implementing an aspect. With reference to FIGS. 1 and 2, the SoC 12 may include a cache memory controller 300, a cache memory 302, a main memory controller 304, a main memory 306, a stream monitor 310, an access monitor 314, an identifier 316, and other components such as the components of the SoC 12 described above. The SoC 12 may also include or be communicatively connected to a storage memory controller 308 and the storage memory 24. Each of the cache memory 302, the main memory 306, and the storage memory 24 may be configured to store memory contents, such as data and/or processor-executable code. The memory contents may be stored a specific locations identified by physical addresses of the cache memory 302, the main memory 306, and the storage memory 24. In an aspect, memory access requests to the memories 24, 302, 306 may be made using a virtual address that may be translated to the physical address of the respective memory 24, 302, 306 in order to retrieve the requested memory contents of the memory access request. The storage locations of any of the data and/or processor-executable code may change with time. The physical addresses associated with the data and/or processor-executable code may be updated in a data structure mapping the locations of the data and/or processor-executable code for access by the processor 14.

The cache memory 302 may be configured to temporarily store data and/or processor-executable code for quicker access than is achievable accessing the main memory 306 or the storage memory 24. The cache memory 302 may be dedicated for use by a single processor 14 or shared between multiple processors 14, and/or subsystems (not shown) of the SoC 12. In an aspect, the cache memory 302 may be part of the processor 14, and may be dedicated for use by a single processor core or shared between multiple processor cores of the processor 14. The cache memory controller 300 may manage access to the cache memory 302 by various processors 14 and subsystems (not shown) of the SoC 12. The cache memory controller 300 may also manage memory access requests for access from the cache memory controller 300 to the main memory 306 and the storage memory 24 for retrieving memory contents that may be requested from the cache memory 302 by the processor 14, but not found in the cache memory 302 resulting in a cache miss.

The main memory 306 may be configured to temporarily store data and/or processor-executable code for quicker access than when accessing the storage memory 24. The main memory 306 may be available for access by the processors 14 of one or more SoCs 12, and/or subsystems (not shown) of the SoC 12. The main memory controller 304 may manage access to the main memory 306 by various processors 14 and subsystems (not shown) of the SoC 12 and computing device. The main memory controller 304 may also manage memory access requests for access by the main memory controller 304 to the storage memory 24 for retrieving memory contents that may be requested from the main memory 306 by the processor 14 or the cache memory controller 300, but not found in the main memory 305 resulting in a main memory miss.

The storage memory 24 may be configured to provide persistent storage of data and/or processor-executable code for retention when the computing device is not powered. The storage memory 24 may have the capacity to store more data and/or processor-executable code than the cache memory 302 and the main memory 306, and to store data and/or processor-executable code including those not being used or predicted for used in the near future by the processors 14 or subsystems (not shown) of the SoC 12. The storage memory 24 may be available for access by the processors 14 of one or more SoCs 12, and/or subsystems (not shown) of the SoC 12. The storage memory controller 308 may manage access to the storage memory 24 by various processors 14 and subsystems (not shown) of the SoC 12 and computing device. The storage memory controller 24 may also manage memory access requests for access from the cache memory controller 300 and the main memory controller 304 to the storage memory 24 for retrieving memory contents that may be requested from the cache memory 302 or the main memory 306 by the processor 14, but not found in the cache memory 302 or the main memory 305 resulting in a cache memory miss or a main memory miss.

The stream monitor 310 may be configured to monitor communications between the processor 14, subsystems of the SoC 12 (not shown), the cache memory controller 300, the main memory controller 300, and the storage memory controller 308, and to determine whether the communications are indicative of an ROP attack. The stream monitor 310 may monitor communications to/from the memories 24, 302, 306 for accesses of memory regions containing the processor-executable code, as discusses in greater with reference to the access monitor 314. The stream monitor 310 may determine whether the communications to the memories 24, 302, 306 for accesses of memory regions containing the processor-executable code are indicative of an ROP attack working with the identifier 316. Monitoring the communications between the components of the SoC 12 may include monitoring instruction request lines used to approximate or recognize ROP attacks. The instruction request lines may be used to identify the memory address of the requested processor-executable code of a memory access request to the memories 24, 302, 306. Monitoring all instruction request lines may be overly taxing or inefficient in some implementations because not all the requested processor-executable code may be of interest for approximating or detecting ROP attacks. So in an aspect, monitoring instruction request lines may be implemented selectively by determining memory addresses of interest in one or more of the memories 24, 302, 306 associated with processor execution events that are vulnerable or more likely to be the subject of an ROP attack.

The access monitor 314 may be configured to monitor communications between the processor 14, subsystems of the SoC 12 (not shown), the cache memory controller 300, the main memory controller 300, and the storage memory controller 308. The access monitor 314 may monitor these communications by monitoring the communication activity on one or more communications buses 312 connecting the processor 14 and/or the subsystems of the SoC 12 (not shown) to each of the controllers 300, 304, and 308. The access monitor 314 may monitor communications to the memories 24, 302, 306 for accesses of memory regions containing the processor-executable code. The sizes and/or types of the memory regions may vary for different aspects, including a line, a block, a page, or any other memory unit size and/or type. In an aspect, the access monitor 314 may monitor communications for memory access requests containing entry point addresses to the memories 24, 304, and 306.

The identifier 316 may be configured to detect or identify an ROP attack related to the memory access requests observed by the access monitor 314. ROP attacks result in anomalous program execution flows that induce anomalous memory access sequences. Before a processor-executable code is executed the code has to be fetched from memory 24, 304, and 306. The identifier 316 may detect when an anomalous memory access sequence occurs and determine whether the anomalous memory access sequence is indicative of an ROP attack causing an anomalous program execution flow. The identifier 316 may be provided with at least one next memory address for a next processor-executable code based on a previous memory address of a previous processor-executable code. The identifier 316 may receive a memory address of a memory access request, such as a memory access request in progress on the computing device, for a processor-executable code from the access monitor 314. Using, the received memory address, the identifier 316 may compare the memory address to the next memory address and determine whether the comparison indicates that the current memory access request is an ROP attack (e.g., indicating that the processor-executable code of the memory address does not match the next processor-executable code of the next memory address). These and other aspects of the identifier 316 are described in greater detail with reference to FIGS. 5-11.

In an aspect, processor-executable code may reference to other processor-executable code and/or data stored in the memories 24, 302, 306 using virtual addresses. For example, the use of virtual addresses for executable code is common when the processor-executable code is executed via a virtual machine run by the processor 14. However communications between some of the components of the SoC 12 via the communication buses 312 may identify locations in the memories 24, 302, 306 using physical addresses. The access monitor 314 may monitor memory access requests at various points in the execution of an application or routine, some using virtual addresses and some using physical addresses. The stream monitor 310, like other components of the SoC 12, may be configured to understand and use physical addresses to communicate among the components of the SoC 12.

In an aspect, the stream monitor 310 may also be configured to understand and use virtual addresses in its communications. An aspect of the stream monitor 310 handling virtual addresses may include use of a software component, which may be part of the operating system (OS) kernel, to perform translations from virtual addresses to physical addresses as needed by the identifier 316. In an aspect, a translation lookaside buffer (TLB) may be monitored during a memory access request to determine the physical address range, translated by the TLB, for monitoring. In response to the processor-executable code executing, the memory region for monitoring defined by the physical address range may be stored on a content-addressable memory (CAM) array, and the addresses may be compared during a refill. In an aspect, code may be injected into each virtual address space to access the region for monitoring defined by the physical address range.

In an aspect, the process described above and with reference to FIGS. 5-11 may be applied to monitoring memory access requests for data rather than for processor-executable code. Data producing components may be mapped to memory regions where the components read and write data. The stream monitor 310 may detect reads from the mapped memory region to verify the component or module that is reading the location, and also detect writes to the mapped memory region in case an attacker attempts to corrupt the data.

The stream monitor 310, the access monitor 314, and the identifier 316 may be implemented as software executed by the processor 14, as dedicated hardware (e.g., on a programmable processor device), or as a combination of software and hardware modules. Some or all of the components of the SoC 12 may be differently arranged and/or combined while still serving the necessary functions. Moreover, the SoC 12 may not be limited to one of each of the components, and multiple instances of each component may be included in various configurations of the SoC 12. Various aspect configurations of the SoC 12 may include components, such as the main memory controller 304, the main memory 306, and stream monitor 310 separate from, but connected to the SoC 12 via the communication buses 312. Various aspect configurations may include the stream monitor 310 having one or more access monitors 314 a part of and/or separate from, but connected to the SoC 12, and configured to monitor a dedicated memory 24, 302, 306 or group of memories 24, 302, 306. The stream monitor 310 may include a central or distributed identifier 316 a part of or separate from, but connected to the SoC 12, and connected to the one or more stream monitors 310.

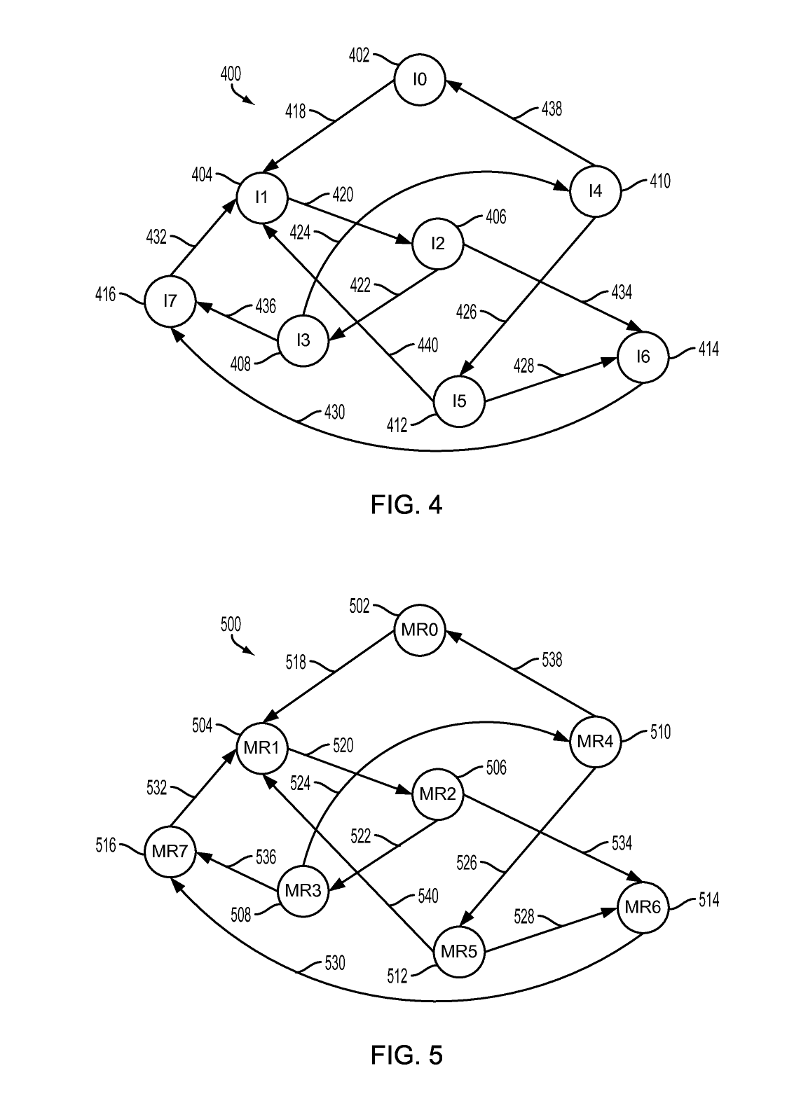

FIG. 4 is an example of an interprocedural control flow graph 400 for a program in accordance with an aspect. A program may include instructions I0-I7 for execution by the computing device. The interprocedural control flow graph 400 may include a number of nodes 402-416, and each node 402-416 may represent the instruction I0-I7. The nodes 402-416 may be connected by a number of edges 418-440, and each edge 418-440 may represent a control-flow transition (e.g., jumps, calls, returns, etc.) between the instructions I0-I7.

The interprocedural control flow graph 400 may be derived from the program in multiple ways. For example, static analysis of the program code while the program is not being executed may be implemented to read the program code and determine the instructions of the program and the control-flow transitions that link them together based. Dynamic analysis of the program execution may be implemented while the program executes to determine the instructions of the program as they are implemented and the control-flow transitions that link them together as each instruction and control-flow transition occurs. A hybrid of static and dynamic analysis of the program code and execution may also be implemented. In an aspect, any of these analyses may be implemented to derive the interprocedural control flow graph 400 prior to installation of the program on the computing device, such that installation of the program may include generating or receiving the interprocedural control flow graph 400. In an aspect, the computing device may derive the interprocedural control flow graph 400 after installation but before execution of the program on the computing device.

FIG. 5 is an example of a memory traversal map 500 for a program in accordance with an aspect. The program may be the same as the program resulting in the interprocedural control flow graph 400, or may contain more nodes, fewer nodes, more edges, or fewer edges than the interprocedural control flow graph. The memory traversal map 400 shows the order in which code memory regions MR0-MR7 of the memories of the computing device may be accessed for program execution on the computing device. The order for accessing the code memory regions for the program execution may be dictated in part by a memory layout selected by a compiler and/or linker of the computing device.

The memory traversal map may be derived from the interprocedural control flow graph 400 and a code map of the program. The memory traversal map 500 may have nodes 502-516 that represent the memory regions MR0-MR7, which may be converted from the nodes 402-416 representing the instructions I0-I7 of the memory traversal map 400. In other words, a memory region MR0-MR7 may correspond to an instruction I0-I7 from a node 402-416 converted to a corresponding node 502-516. The memory traversal map 500 may include edges 518-540 that represent an adjacency of one node 502-516 to another node 502-516 during the program's execution. Nodes 502-516 adjacent to another node 518-540, or directly connected by an edge 518-540, represent the memory regions MR0-MR7 that may be the next memory address of a memory access request expected during execution of the program. In the example illustrated in FIG. 5, node 512 may correspond to an executed instruction IS retrieved from a memory at memory region MR5. The nodes adjacent to node 512 in FIG. 5, namely nodes 504, 510, and 514, correspond to memory regions MR1, MR4, and MR6, respectively. Thus, the memory traversal map 500 indicates that the next memory addresses provided to the identifier may be at least one of a memory address corresponding to memory regions MR1, MR4, and MR6. In an aspect, the edges 518-540 may be directional and adjacent nodes may be indicated by the direction of the arrow for the edge 518-540. In the same example now using direction edges, the nodes adjacent to node 512 may be nodes 504 and 514, which correspond to memory regions MR1, and MR6, respectively. Therefore, the next memory addresses provided to the identifier may be at least one of a memory address corresponding to memory regions MR1 and MR6.

Programs vary in size and complexity, and therefore the interprocedural control flow graph 400 in FIG. 4 and the memory traversal map 500 FIG. 5 are only examples and not meant to limit the size or structure, including the number of nodes and edges, and the connections between nodes, for any program. A memory traversal map 500 may be derived from a large and/or complex program, and performance overhead of monitoring the memory access requests may increase with the number of memory regions should be monitored to identify an ROP attack. Larger and more complex programs often result in larger and more complex memory traversal maps 500 having more memory regions to monitor.

In an aspect, multiple memory traversal maps 500 may be derived for a single program. The multiple memory traversal maps 500 may include a number of memory traversal maps 500 of varying granularity. The granularity of a memory traversal map 500 may be determined by the size of the memory regions used to monitor for ROP attacks. For example, monitoring for an ROP attack may begin using a certain size memory region, and progress to smaller memory regions as detections of anomalous memory accesses increase. To accommodate the varying granularity of the memory regions used in monitoring for ROP attacks, multiple memory traversal maps 500 may be derived using the varying memory region sizes. Larger memory regions may result in coarser grain memory traversal maps 500, by encompassing multiple program instructions I0-I7 in the same node 502-516 representing a memory region MR0-MR7. This may result in fewer nodes 502-516 and edges 518-540, as nodes 502-516 may be combined, thereby eliminating edges 518-540 between combined nodes 502-516. For the same program, smaller memory regions may result in finer grain memory traversal maps 500, as nodes 502-516 may encompass as few as a single program instruction I0-I7 in a memory region MR0-MR7. This may result in mores nodes 502-516 and edges 518-540, as nodes 502-516 may be divided adding edges 518-540 between the divided nodes 502-516. By using memory traversal maps 500 of varying granularity, it may often be the case that the coarser grain memory traversal maps 500 will be used the majority of the time to detect ROP attacks. The increased size of the memory regions of the coarser grain memory traversal maps 500 may result in fewer memory regions being monitored, thus reducing the performance overhead of monitoring the memory access requests.

In an aspect, portions of the program instructions may be identified as vulnerable or more likely to be affected by an ROP attack (e.g., code that interacts with network inputs, code that invokes system calls, code for financial transactions). Such vulnerable sections of the program instructions may be identified and the derivation of the memory traversal maps 500 may be directed to include memory regions for the vulnerable sections of the program instructions and ignore less vulnerable sections of the program instructions. By focusing the memory traversal maps 500 on the vulnerable sections of the program instructions, the memory traversal maps 500 may include fewer memory regions for monitoring, thus recuing the performance overhead of monitoring the memory access requests. In an aspect, rather than limiting the nodes 502-516 derived for the memory traversal maps 500, the nodes 502-516, corresponding to memory regions MR0-MR7 having vulnerable sections of the program instructions may be indicated as vulnerable and the computing device may limit the monitoring to memory accesses of the vulnerable nodes 502-516.

In an aspect, the memory traversal map 500 may be converted from the interprocedural control flow graph 400 and code map prior to installation of the program on the computing device, such that the installation of the program may include uploading of the memory traversal map 500.

In an aspect, the computing device may derive the memory traversal map 500 from the interprocedural control flow graph 400 and the code map after installation of the program on the computing device.

In an aspect, the memory traversal map 500 may be derived a single time to be used for each instance of execution of the program.

In an aspect, the memory traversal map 500 may be derived for each instance of execution of the program, as the available memory regions of the computing device may dictate which memory regions may be assigned to memory regions MR0-MR7 when loading the program processor-executable instructions to a memory for execution of the program.

In an aspect, a data structure of a graph for storing the memory traversal map 500 may be preferred over a table because the graph may require less memory resources to store on the computing device to of represent the relationships of the memory regions for the execution of the program. The reduced memory resource requirements are important for mobile computing devices where memory resources are limited and additional memory resources incur costs that are difficult to recover.

The descriptions of the various aspects for the determination of whether memory access requests are ROP attacks are based on memory addresses, such as entry point addresses to the memories. The entry point address is simply one example of many factors that may be used to identify ROP attacks. References to the entry point address in the descriptions of the various aspects are for example purposes only and are not meant to be limiting as to the factors that may be used to identify ROP attacks. Similarly, the descriptions of various aspects of the memory traversal map 500 are also based on same factor of memory addresses, such as entry point addresses to the memories, for simplicity, and similar maps may be derived from the interprocedural control flow graph 400 for the other factors.

In an aspect, monitoring the communications between the components of the SoC 12 may include monitoring instruction request lines, and using a combination of factors to approximate or recognize ROP attacks. In various aspects, the entry point address to the memories may not suffice to identify the processor-executable code requested for execution. For example, the memories may be divided into storage units, such as the various memory regions described above. The size of a memory region may vary for the different memories. In an aspect where a memory region contains a single processor-executable code, the entry point address indicating a certain memory region may be sufficient to use for identifying ROP attack. In an aspect in which a memory region contains at least part of multiple processor-executable codes, the entry point address indicating a certain memory region may not be able to identify an ROP attack.

As described above, a factor for identifying the ROP attack may not always identify the ROP attack. This may cause ambiguity in identifying the ROP attack. In an aspect, the access monitor 316 may observe at least two of the following factors related to a memory access request, and the identifier 316 may employ at least two of the observed factors to identify the processor-executable code of a memory access request:

Memory region containing a function's entry point address;

Memory region containing a function's exit point address;

Memory region containing callee functions;

Memory region containing caller functions;

Memory region containing parameters (e.g., non-integers, buffers);

Memory region containing unique instructions and patterns (e.g., loops);

Memory region containing function-local variables; and

Memory region containing a function's return value.

The overhead cost of monitoring for the factor(s) for identifying ROP attacks may cause degradation of performance of the computing device for various tasks and resources. Such tasks may include general or specific processing, including identifying the ROP attacks. The performance degradation on resources may include power availability. Substituting a factor(s) with lower overhead cost for the factor(s) with greater overhead cost may help reduce the performance degradation.

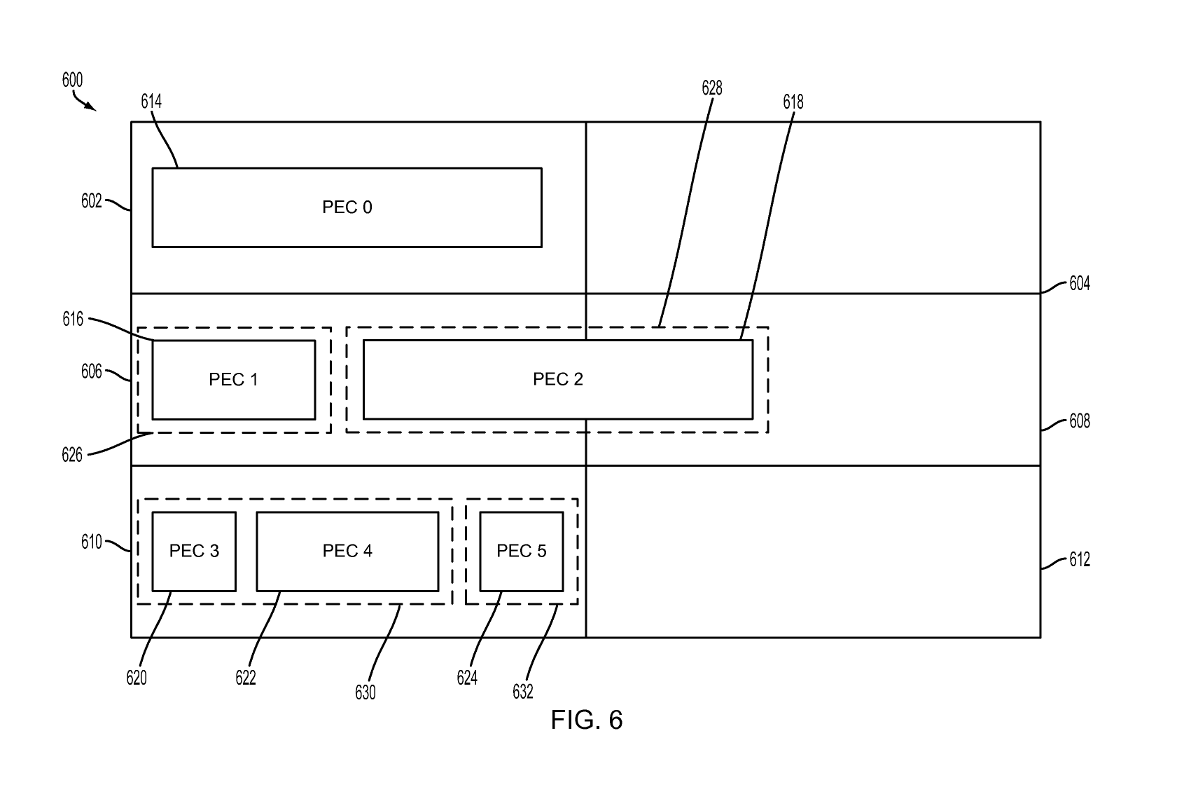

FIG. 6 is an illustration of memory contents stored in various configurations relative to respective memory regions 602-612 in a memory 600 in accordance with an aspect. The memory 600 may be any of the above described memories, for example, the cache memory, the main memory, or the storage memory. The memory 600 may be divided into the memory regions 602-612. As discussed above, the memory regions 602-612 may be of any memory unit size and/or type, such as a line, a block, or a page. The memory regions 602-612 may be the memory unit size and/or type that may be used for memory access request in a respective computing device. In an aspect, the memory regions 602-612 may be subdivided into smaller memory regions 628-632.

Memory contents stored in the memory 600 may include data and/or processor-executable code. For ease of explanation, and without limiting the scope of the description or claims, the following examples are expressed in terms of processor-executable code. The memory regions 602-612 may contain one or more processor-executable codes (PECs) 614-624. For example, the memory region 602 may store a single processor-executable code (PEC 0) 614 within the boundaries of the memory region 602. In another example, the memory region 606 may store one or more processor-executable codes (PEC 1) 616, (PEC 2) 618 that may extend beyond the boundaries of memory region 606 into memory region 608. In another example, the memory region 610 may store multiple processor-executable codes (PEC 3) 620, (PEC 4) 622, and (PEC 5) 624 within the boundaries of the memory region 610. The size of the memory region 602-612 monitored and/or the number and/or type of processor-executable codes 614-624 stored in the memory regions 602-612 may affect the efficiency of monitoring memory access requests for ROP attacks.

In the case of a memory region 602 storing a single processor-executable code (PEC 0) 614, it may be sufficient to use the entry point address to the memory region 602 for the memory 600 as the next address for comparison in identifying an ROP attack. Because the memory region 602 stores a single processor-executable code (PEC 0) 614, when using the entry point address to memory region 602 as the next address, a confirmation by the identifier that the memory address of a memory address request matches the next memory address may be sufficient to determine that an ROP attack is not occurring.

In the case of processor executable code spanning more than a single memory region, using the entry point address to a memory region 606 or 610 for the memory 600 as the next address for comparison in identifying an ROP attack may not be as accurate in identifying ROP attacks as in the case in which all of the executable code is in a single memory region, such as having a single entry point address to the memory region 602. Since each of memory regions 606, 610 may store multiple processor-executable codes 616-624, confirmation by the identifier that the memory address of a memory address request matches the next memory address may lead to a false negative. A false negative may include the identification of no ROP attack for access to a respective memory region 606, 610 when less than all of the processor-executable codes 616-624 of the respective memory region 606, 610 are accounted for by the next memory address. In this example, while the next memory address may indicate that at least one of the multiple processor-executable codes 616-624 may be valid for execution, not all of memory addresses may be valid. Therefore, relying on the entry point address of the memory access request alone may produce overly inclusive information for the identifier to make accurate determinations of ROP attacks.

Identifying ROP attacks by accesses to the memory regions 606, 610 may employ or trigger the use of finer granularity memory traversal maps, which may specify memory regions 628-632 for individual processor-executable codes 616-624 or smaller groups of processor-executable codes 616-624. The finer granularity memory traversal maps may be used to specify entry point addresses of the memory regions 628-632 that may not be included in a coarser grain memory traversal map that includes the entry point address of the memory regions 602-612. In an aspect, detection of an access to memory regions 606, 610 may trigger the use of finer grain memory traversal maps to determine whether an ROP attack may be occurring by accessing the memory regions 628-632.

In an aspect, the stream monitor may track potential ROP attacks, or inconclusive determinations of ROP attacks based on accesses to the memory regions 602-612. Each potential ROP attack may increase a tally of a cumulative anomaly score, and the use of the finer grain memory traversal maps may be triggered in response to the cumulative anomaly score exceeding an anomaly score threshold. In an aspect, accesses to the different memory regions 602-612 or the memory traversal maps may be assigned varying anomaly scores to be added to the cumulative anomaly score when such access occurs. The anomaly scores assigned to an access of the memory regions 602-612 or the memory traversal maps may indicate whether it is more or less likely that such an access is indicative of an ROP attack. For example, memory region 606 contains the processor-executable codes (PEC 1) 616 and (PEC 2) 618. In the example, the previous memory address may result in the entry point address to memory region 606 to be a valid next memory address because contains the processor-executable code (PEC 1) 616 may follow from the execution of the previous processor-executable code. However, the memory region 606 may also be assigned a low anomaly score value because there is some potential that an access to memory region 606 may include accessing the processor-executable code (PEC 2) 618, which may not follow from the execution of the previous processor-executable code. The assigned anomaly score for memory region 606 may be low because there is only one potential invalid processor-executable code (PEC 2) 618 that may be accessed. The assigned anomaly score for memory region 606 may be increased in response to the invalid processor-executable code (PEC 2) 618 being vulnerable or a likely target of ROP attacks (e.g., code that interacts with network inputs, code that invokes system calls, code for financial transaction).

In an aspect, the cumulative anomaly score may be compared to various thresholds which may determine increasingly fine levels of granularity of the memory traversal maps to use. In an aspect, the cumulative anomaly score may be compared to a threshold that may indicate an ROP attack and trigger a configurable security response.

In an aspect, entire memory traversal maps may be associated with an anomaly score. Lower anomaly scores may be assigned to memory traversal maps that have a higher likelihood of inaccuracy than memory traversal maps with higher anomaly scores. Each detected mismatch between a memory address of a memory access request and a next memory address from a memory traversal map may result in adding the anomaly score to the cumulative anomaly score. The cumulative anomaly score exceeding the anomaly score threshold may indicate an ROP attack or trigger the use of a finer grain memory traversal map.

In an aspect a cumulative number of mismatches between a memory address of a memory access request and a next memory address from a memory traversal map may be tracked. Tracking the number of memory access request address vs. memory map mismatches may be use in a manner similar to the use of anomaly scores described above when all of the anomaly scores are equal constants. In an aspect, a specified number of memory access request occurring over a specified elapsed time without exceeding or increasing the cumulative anomaly score may indicate that an ROP attack is unlikely. In response to such a determination, the anomaly score may be decrease or reset and use of a coarser grain memory traversal map may be initiated.

Identifying ROP attacks by accesses to the memory regions 606, 610 may employ the aspect of using a combination of factors, as illustrated in the examples provided above. Since the entry point address alone may produce overly inclusive information, use of other factors may enable the identifier to identify a specific processor-executable code 616-624 from the group of other processor-executable codes 616-624 stored in the same memory region 606, 610. While unnecessary, this aspect may also be used to identify the single processor-executable codes (PEC 0) 614 stored in a single memory region 602. The identifier may use the memory accesses of the processor-executable codes 614-624 to determine whether the accesses indicate ROP attacks.

In an example, the entry point address and the exit point address of the memory access may be used to identify processor-executable code (PEC 2) 618. Since in this example the processor-executable code (PEC 2) 618 is partially stored in memory region 606 and in memory region 608, the entry point address and exit point address may be associated with a respective memory region 606, 608. Among any of the processor-executable codes 616, 618 stored in memory regions 606, 608, the combination of an entry point address associated with memory region 606 and an exit point address associated with memory region 608 is unique to processor-executable code (PEC 2) 618. The identifier may use the access of the processor-executable code (PEC 2) 618 to determine whether the access indicates an ROP attack.

Other factors may be applied to identify any of the processor-executable codes 616-624. For example, any number of other factors may be predetermined to be associated with one or more processor-executable codes 616-624. The stream monitor may be configured to identify any combination of such factors. In response to a memory access request, the stream monitor may identify the factors and compare the factors to the processor-executable codes 616-624 with which they are related. For any two or more factors identified by the stream monitor, the processor-executable codes 616-624 associated with each of the identified factors may be the processor-executable code 616-624 targeted by the memory access request. The stream monitor may be configured such that the factors it identifies are used to determine whether the accesses of the processor-executable codes 616-624 are indicative of ROP attacks.

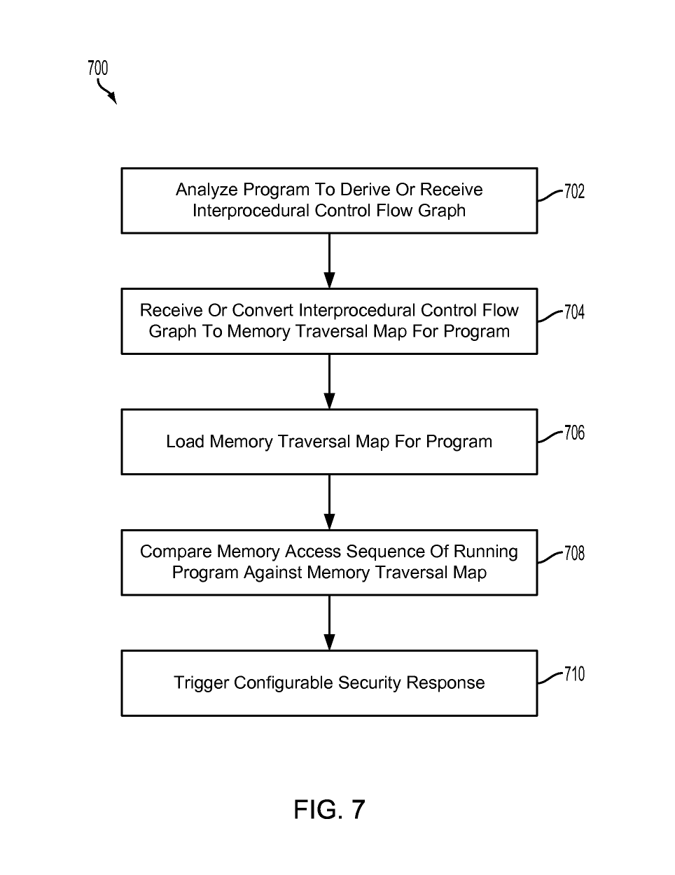

FIG. 7 illustrates an aspect method 700 for implementing detection of an ROP attack using memory monitoring. With reference to FIGS. 1-6, the method 700 may be executed in a computing device using software, general purpose or dedicated hardware, such as the processor and/or the stream monitor, the access monitor, and the identifier, or a combination of software and hardware. In block 702, the computing device may receive an interprocedural control flow graph for a program derived by another computing device. The received interprocedural control flow graph may be provided to the computing device with the program. In an aspect, in block 702, the computing device may analyze the program to derive the interprocedural control flow graph. As described with reference to FIG. 4, the interprocedural control flow graph for the program may be derived using static analysis of the program code while the program is not being executed to read the program code and determine the instructions of the program and the control-flow transitions that link them together based. In an aspect, interprocedural control flow graph for the program may be derived using dynamic analysis of the program execution while the program executes to determine the instructions of the program as they are implemented and the control-flow transitions that link them together as each instruction and control-flow transition occurs. In an aspect, the interprocedural control flow graph for the program may be derived using a hybrid of static and dynamic analysis of the program code and execution may also be implemented.

In block 704, the computing device may obtain a memory traversal map for the program. In an aspect, the computing device may receive the memory traversal map for the program converted from the interprocedural control flow graph by another computing device, and may be provided to the computing device with the program. In an aspect, the computing device may convert the interprocedural control flow graph to a memory traversal map for the program. As described with reference to FIG. 5, deriving the memory traversal map for the program may include creating the memory traversal map for the program with nodes representing memory regions of a memory of the computing device, and corresponding to at least one node of the interprocedural control flow graph representing a processor-executable code of the program. Thus, the memory traversal map may indicate where the processor-executable code of the interprocedural control flow graph is stored in memory.

Deriving the memory traversal map for the program in block 704 may also include creating the memory traversal map for the program with edges connecting the nodes and representing which of the nodes are adjacent in execution of the program. In other words, the edges of the memory traversal map indicate which next memory regions may be accessed following the access of a previous memory region. In an aspect, the edges may be directional, further indicating more specifically which of the nodes connected to another node are adjacent in execution of the program and of the connected nodes are not adjacent via the directionality of the edges.

In an aspect, the memory traversal map derived or received in block 704 may represent the entire program or a portion of the program. The portion of the program represented by the memory traversal map may include a portion of the program likely to be affected by an ROP attack (e.g., code that interacts with network inputs, code that invokes system calls, code for financial transactions).

In an aspect, multiple memory traversal maps may be derived or received in block 704 representing different portions of the program. In an aspect, multiple memory traversal maps may be derived or received using varying granularity for the sizes of the memory regions. For example, a coarse grain memory traversal map may use larger memory regions than a fine grain memory traversal map. As a result, the nodes of the coarse grain memory traversal map may correspond to multiple nodes of the interprocedural control flow graph. Further, the fine grain memory traversal map may use smaller memory regions than the coarse grain memory traversal map. As a result, the nodes of the fine grain memory traversal map may come closer to a one-to-one relationship with the nodes of the interprocedural control flow graph.

In an aspect, the memory traversal map derived or received in block 704 may be associated with an anomaly score, which may represent levels of confidence in the accuracy of the memory traversal map. In an aspect, the nodes of the memory traversal map may be associated with, anomaly scores that may represent the likelihood that a mismatch between a memory address of a memory access request and a next memory address for the program may indicate an ROP attack. The anomaly scores may be used to determine whether an ROP attack is detected or whether to use a finer grain memory traversal map to detect an ROP attack.

In an aspect, the memory traversal map may be a virtual memory traversal map that may be created from the interprocedural control flow graph and a virtual memory layout of the program. The virtual memory traversal map may include nodes corresponding to virtual memory regions (such as virtual memory pages or virtually addressed cache blocks) and edges between these nodes corresponding to control flow transitions between program code residing in those virtual memory regions. The virtual memory traversal map may be updated in response to the operating system allocating new virtual memory on behalf of the program; any new virtual memory regions containing new program code (such as regions containing newly loaded shared libraries) may be added to the traversal map as new nodes. In another aspect, the memory traversal map may be a physical memory traversal map that may be created from the interprocedural control flow graph, the virtual memory layout of the program, and the operating system's (or hypervisor's) virtual-to-physical page map. The physical memory traversal map may include nodes corresponding to physical memory regions (such as physical page frames or physically addressed cache blocks) and edges between these nodes corresponding to control flow transitions between program code residing in those physical memory regions. The physical memory traversal map may be updated in response to the operating system (or the hypervisor) changing a virtual-to-physical page map. For example, in response to the contents of a physical page frame being swapped out of memory onto secondary storage (such as a hard disk drive), the physical memory traversal map may be updated by removing the node corresponding to that physical page frame. Conversely, in response to a physical page frame being filled in with data from secondary storage, a new node may be added to the memory traversal map. Either virtual memory traversal map or the physical memory traversal map could be used in the detection phase described below.

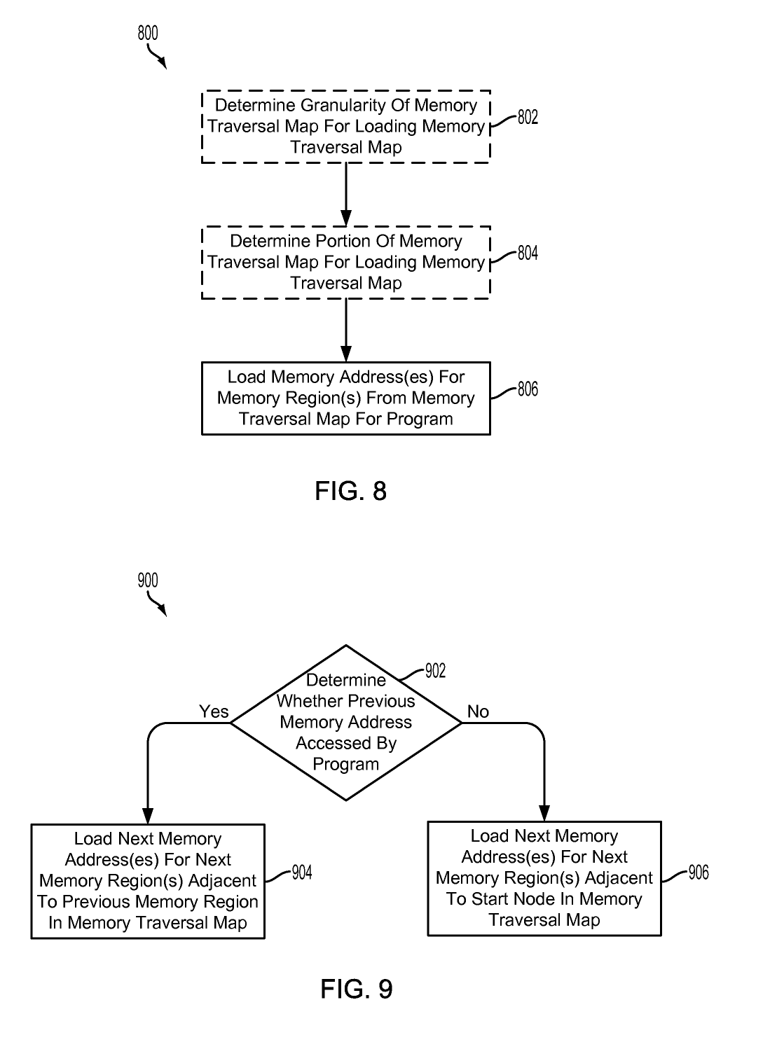

In block 706, the computing device may load the memory traversal map for the program. As described in further detail with reference to FIGS. 8 and 9, the computing device may load the memory traversal map to the stream monitor, and more specifically to the identifier. In an aspect, the computing device may load the entire memory traversal map, a portion of the memory traversal map representing a portion of the program likely to be affected by an ROP attack (e.g., code that interacts with network inputs, code that invokes system calls, code for financial transactions), and/or the memory traversal map of a particular granularity. In an aspect, the computing device may load the next memory address of the memory region adjacent to a memory region of a previous memory address requested by a previous memory access request. In an aspect, the computing device may load the memory traversal map upon calling a program to be run on the computing device, upon initializing the program on the computing device, or while the program is running on the computing device.

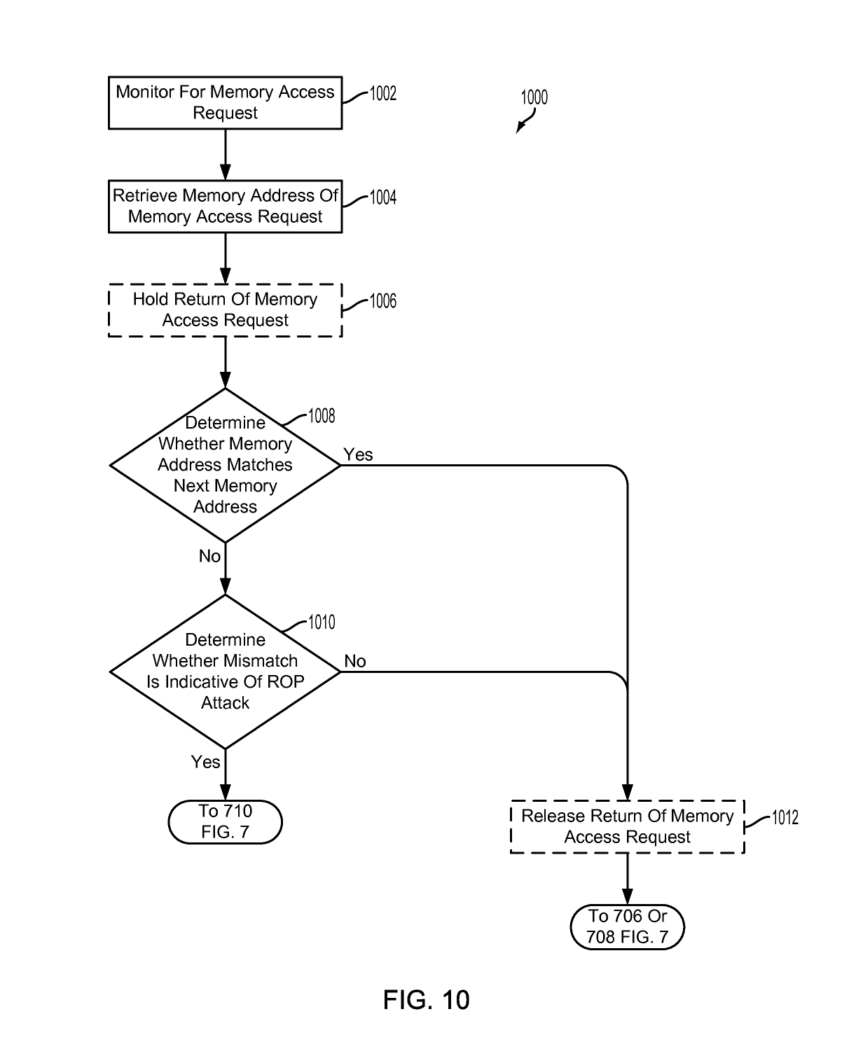

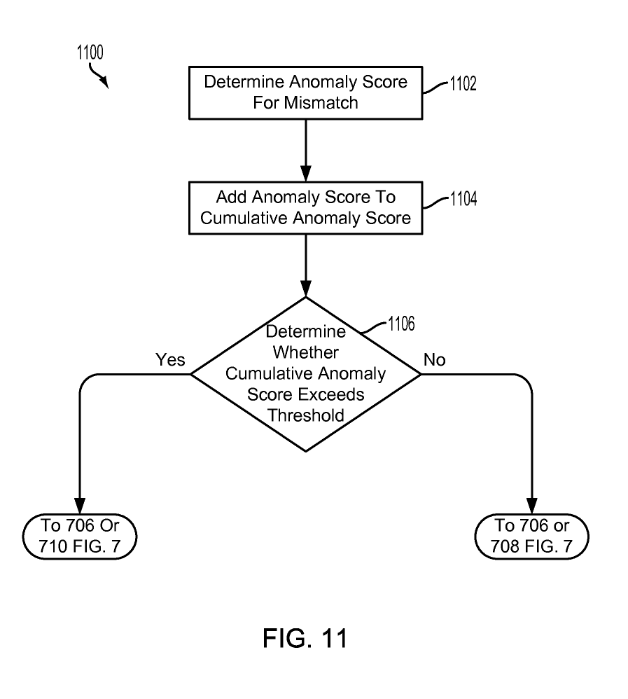

In block 708, the computing device may compare a memory access sequence of a running program against the memory traversal map of the program. As described in further detail with reference to FIGS. 10 and 11, the computing device may compare a memory address of a memory access request to the memory addresses of the memory traversal map loaded by the computing device. In particular, the memory address of the memory access request may be compared to the next memory address of the memory region adjacent to a memory region of a previous memory address requested by a previous memory access request. A memory access request address vs. memory traversal map mismatch may indicate a potential ROP attack, triggering the use of a finer grain memory traversal map to increase the accuracy of the determination of an ROP attack. In an aspect, a memory access request address vs. memory traversal map mismatch may indicate an ROP attack triggering a configurable security response in block 710. The configurable security response may include a variety of actions by the computing device. A non-exhaustive list of configurable security responses that may be implemented in block 710 includes raising an alert, terminating the program, continue program execution in a sandbox for forensic purposes, attempting to repair program state and continue execution of the program, and/or rolling back the program state (with help of a checkpointing mechanism) and continuing execution of the program.

FIG. 8 illustrates an aspect method 800 for loading a memory traversal map for a program. The method 800 may be executed in a computing device using software, general purpose or dedicated hardware, such as the processor and/or the stream monitor, the access monitor, and the identifier, or a combination of software and hardware. The method 800 includes an aspect of operations that may be implemented in block 706 of method 700 described above.

In optional block 802, the computing device may determine a granularity of a memory traversal map for loading the memory traversal map. As described with reference to FIGS. 5-7, the computing device may receive or derive multiple memory traversal maps for the same program having varying levels of granularity. In an aspect, in response to initializing the program, the computing device may select a memory traversal map with a granularity that is designated (e.g., by default) by the computing device or designated by the program. In an aspect, the level of granularity of the memory traversal map may be determined for a previously running program based on the cumulative anomaly score. For example, in response to the cumulative anomaly score exceeding the cumulative anomaly score for a currently loaded memory traversal map at a certain granularity, the memory traversal map selected for loading may have greater granularity (i.e., addresses memory access sequences in finer detail). In another example, after a specified number of memory access request or a specified elapsed time without exceeding or increasing the cumulative anomaly score, a memory traversal map with less granularity may be selected for loading.

In optional block 804, the computing device may determine a portion of a memory traversal map for loading as the memory traversal map that will be compared to memory request access addresses. As described with reference to FIGS. 5-7, a memory traversal map or a portion of a memory traversal map may represent a portion of the program that is vulnerable or likely to be affected by an ROP attack (e.g., code that interacts with network inputs, code that invokes system calls, code for financial transactions). In an aspect, the computing device may not have the resources available to monitor more than a certain number of memory access requests, or may be configured by a security setting to only be concerned with ROP attacks on such sensitive portions of programs. The computing device may determine that only memory access requests for certain memory addresses corresponding to memory regions representing the sensitive portions of the program will be monitored. Therefore, the computing device may determine the portions of the memory traversal map that correspond to the sensitive portions of the program and designate those memory traversal map portions for loading.

In block 806, the computing device may load the memory address(es) for memory region(s) from the selected memory traversal map for the program. In an aspect, the memory address(es) for the memory region(s) from the memory traversal map loaded by the computing device may be designated in optional block 802 and/or optional block 804. In an aspect, the memory address(es) for the memory region(s) from the memory traversal map loaded by the computing device may include all of the memory addresses from the memory traversal map. In such an aspect, the computing device may track the progress of the program through the memory traversal map. Tracking the progress may allow the computing device to determine whether the program proceeds between adjacent nodes of the memory traversal map, or whether there are anomalous executions indicated by accesses to memory addresses of nonadjacent node or memory addresses not included in the memory traversal map. In response to detecting anomalous executions the computing device may determine whether an ROP attack is detected. In an aspect, the computing device may repeatedly load groups of next memory addresses of the memory regions adjacent to a memory region of a previous memory address requested by a previous memory access request. This aspect may be implemented instead of or using the memory address(es) for the memory region(s) from the memory traversal map loaded by the computing device designated in optional block 802 and/or optional block 804.

FIG. 9 illustrates an aspect method 900 for loading memory addresses for memory regions from a memory traversal map for a program. The method 900 may be executed in a computing device using software, general purpose or dedicated hardware, such as the processor and/or the stream monitor, the access monitor, and the identifier, or a combination of software and hardware. The method 900 includes an aspect of operations that may be implemented in block 806 of method 800 described above.

In determination block 902, the computing device may determine whether a previous memory address of the memory traversal map was accessed by executing the program. By determining whether a previous memory address was accessed by executing the program, the computing device may infer whether the program is just initialized or whether the program has been running. In response to determining that a previous memory address of the memory traversal map was accessed by executing the program (i.e., determination block=“Yes”), the computing device may load next memory address(es) for next memory region(s) adjacent to the previous memory regions of the previous memory address requested by a previous memory access request. In an aspect, the computing device may load only the next memory address(es) to reduce the amount of data loaded by the computing device and to reduce the computational complexity of detecting an ROP attack.

In response to determining that a previous memory address of the memory traversal map was not accessed by executing the program (i.e., determination block=“No”), the computing device may next memory address(es) for next memory region(s) adjacent to the previous memory regions adjacent to a start node in the memory traversal map. In an aspect, upon initialization of a program by the computing device, a previous memory access request by the program may not yet have occurred, thus there may not be a previous memory address that can be used to identify a previous memory region in the memory traversal map. The memory traversal map for the program may include a start node that may represent a memory region that is a first accessed memory region by a first memory access request of the program each time the program is initialized. Therefore, the memory regions of the memory traversal map adjacent to the memory region of the start node may be the next memory regions for the execution of the program.

FIG. 10 illustrates an aspect method 1000 for comparing a memory access sequence of a running program against a memory traversal map for the program. The method 1000 may be executed in a computing device using software, general purpose or dedicated hardware, such as the processor and/or the stream monitor, the access monitor, and the identifier, or a combination of software and hardware. The method 1000 includes an aspect of operations that may be implemented in block 708 of method 700 described above.

In block 1002, the computing device may monitor the instruction request lines to the memories of the computing device for memory access requests to memory addresses corresponding to memory regions of the memory traversal map for the program.

In block 1004, the computing device may retrieve the memory address specified by a memory access request to the memories of the computing device. As discussed with reference to FIG. 3 the memory address of the memory access request may be either a physical address or a virtual address of the memory accessed by the memory access request. The computing device may do any translations between a physical address and a virtual address when needed to compare a memory address of a memory access request and a memory address loaded from the memory traversal map.

In optional block 1006, the computing device may hold a return code or data for a memory access request so that the computing device may complete a comparison of the memory address of the memory access request and the next memory address(es) of the memory traversal map loaded by the computing device.

In determination block 1008, the computing device may determine whether a memory address of a memory access request matches a next memory address of the memory traversal map to determine whether the memory address and the next memory address match.

In response to determining that the memory address of the memory access request does not match the next memory address of the memory traversal map (i.e., determination block 1008=“No”), the computing device may determine whether the mismatch of the memory address and the next memory address(es) is indicative of an ROP attack in determination block 1010. While a mismatch of the memory address and the next memory address(es) may be indicative of an anomalous execution of the program, not every anomalous execution may be the result of an ROP attack. For example, the memory address of the memory access request may not actually be anomalous, just anomalous as perceived by the computing device relying on the memory traversal map that may not be completely accurate, inclusive of the all of the memory regions, or fine enough grain to accurately detect an ROP attack. Also, while the memory address of the memory access request may be the result of an anomalous execution of the program, the anomalous execution may not be deemed harmful enough to result in detection an ROP attack and trigger a configurable security response. The memory regions and/or memory traversal maps may be assigned low anomaly scores in these situations in which a detected anomalous execution does not signify an ROP attack based on the detection of the instance of the anomalous execution rather than cumulative instances of anomalous executions. In various aspects, the computing device may determine that mismatch of the memory address and the next memory address(es) is indicative of an ROP attack. A determination of an ROP attack may be based on a variety of factors, including a single mismatch, a cumulative number of mismatches for a number of memory access requests exceeding a mismatch threshold, a cumulative anomaly score exceeding an anomaly score threshold, a mismatch within a certain portion of the memory traversal map, and/or a mismatch within a memory traversal map of a certain granularity.

In response to determining that the mismatch of the memory address and the next memory address(es) is indicative of an ROP attack (i.e., determination block 1010=“Yes”) or, the computing device may trigger a configurable security response in block 710 of method 700 as described with reference to FIG. 7.

In response to determining that the memory address of the memory access request does match the next memory address of the memory traversal map (i.e., determination block 1008=“No”) or in response to determining that the mismatch of the memory address and the next memory address(es) is not indicative of an ROP attack (i.e., determination block 1010=“No”), the computing device may release the return code or data of the memory access request in optional block 1012. In an aspect, the computing device may load the memory traversal map for the program in block 706 of method 700 and/or compare a memory access sequence of a running program against the memory traversal map of the program in block 708 of method 700 as described with reference to FIG. 7. Whether the computing device loads the memory traversal map for the program in block 706 before comparing a memory access sequence of a running program against the memory traversal map of the program in block 708 may depend on the configuration of the computing device and/or the method 1000. If the computing device only loaded a portion of the memory traversal map it may need to load a different portion of the memory traversal map based on the execution of the program, such as loading new next memory address(es) based on the memory address of the memory access request as the previous memory address. In that case, the computing device may load the memory traversal map for the program in block 706. The operations of block 706 may not be performed if the computing device loaded a sufficient portion of the memory traversal map of the program to not require loading more or a different portion of the memory traversal map for the based on the memory address of the memory access request as the previous memory address. Either way, the computing device may compare a memory access sequence of a running program against the memory traversal map of the program in block 708.

In an aspect, while the computing device may not detect an ROP attack, the memory traversal map may be updated in response to a single mismatch, a cumulative number of mismatches for a number of memory access requests exceeding a mismatch threshold, a cumulative anomaly score exceeding an anomaly score threshold, a mismatch within a certain portion of the memory traversal map, and/or a mismatch within a memory traversal map of a certain granularity. For example, the memory traversal map may be updated to increase or decrease the granularity of the memory traversal map of the program, or to load a different portion of the memory traversal map for the program or load new next memory address(es) either based on the factors described above or the memory address of the memory access request as the previous memory address. In such aspects, the computing device may load the memory traversal map for the program in block 706. The operations of block 706 may not be performed if the computing device loaded a sufficient portion of the memory traversal map of the program to not require loading more or a different portion of the memory traversal map for the based on the memory address of the memory access request as the previous memory address. Either way, the computing device may compare a memory access sequence of a running program against the memory traversal map of the program in block 708.

FIG. 11 illustrates an aspect method 1100 for comparing a memory access sequence of a running program against a memory traversal map for the program. The method 1100 may be executed in a computing device using software, general purpose or dedicated hardware, such as the processor and/or the stream monitor, the access monitor, and the identifier, or a combination of software and hardware. The method 1100 includes an aspect of operations that may be implemented in determination block 1010 of method 1000 described above.

In block 1102, the computing device may determine an anomaly score for a given mismatch between a memory access request address and the memory traversal map. The anomaly score may be based on the anomaly score assigned to the memory regions or on the anomaly score of the memory traversal map. In block 1104, the computing device may add the determined anomaly score to a cumulative anomaly score.

In determination block 1106, the computing device may determine whether the cumulative anomaly score exceeds a cumulative anomaly score threshold. In response to determining that the cumulative anomaly score exceeds the cumulative anomaly score threshold (i.e. determination block 1106=“Yes”), the computing device may load the memory traversal map for the program in block 706 of method 700 or to trigger a configurable security response in block 710 of method 700 as described with reference to FIG. 7. Whether the computing device loads the memory traversal map for the program in block 706 or triggers a configurable security response in block 710 may depend on the configuration of the computing device and/or method 1100. As described with reference to FIG. 6, the cumulative anomaly score may be compared to various thresholds in determination block 1106. In an aspect, the cumulative anomaly score may be compared to a threshold that may result in using increasingly fine levels of granularity or different portions of the memory traversal maps, including the next memory address(es) based on the previous memory address. In such aspects, the computing device may load the memory traversal map for the program in block 706. In an aspect, the cumulative anomaly score may be compared to a threshold the may indicate an ROP. In such aspects, the computing device may trigger a configurable security response in block 710.

In response to determining that the cumulative anomaly score does not exceed a cumulative anomaly score threshold (i.e. determination block 1106=“No”), the computing device may load the memory traversal map for the program in block 706 of method 700 and/or compare a memory access sequence of a running program against the memory traversal map of the program in block 708 of method 700 as described with reference to FIG. 7. Whether the computing device loads the memory traversal map for the program in block 706 before comparing a memory access sequence of a running program against the memory traversal map of the program in block 708 may depend on the configuration of the computing device and/or the method 1100. As described with reference to FIG. 10, if the computing device only loaded a portion of the memory traversal map it may need to load a different portion of the memory traversal map in block 706 based on the execution of the program, such as loading new next memory address(es) based on the memory address of the memory access request as the previous memory address. The operations of block 706 may not be performed if the computing device loaded a sufficient portion of the memory traversal map of the program to not require loading more or a different portion of the memory traversal map based on the memory address of the memory access request as the previous memory address. Either way, the computing device may compare a memory access sequence of a running program against the memory traversal map of the program in block 708 as described with reference to FIG. 7.

As described with reference to FIG. 6, the anomaly scores may be equal constants, and the aspects of method 1100 may amount to tracking the number of mismatches that occur.

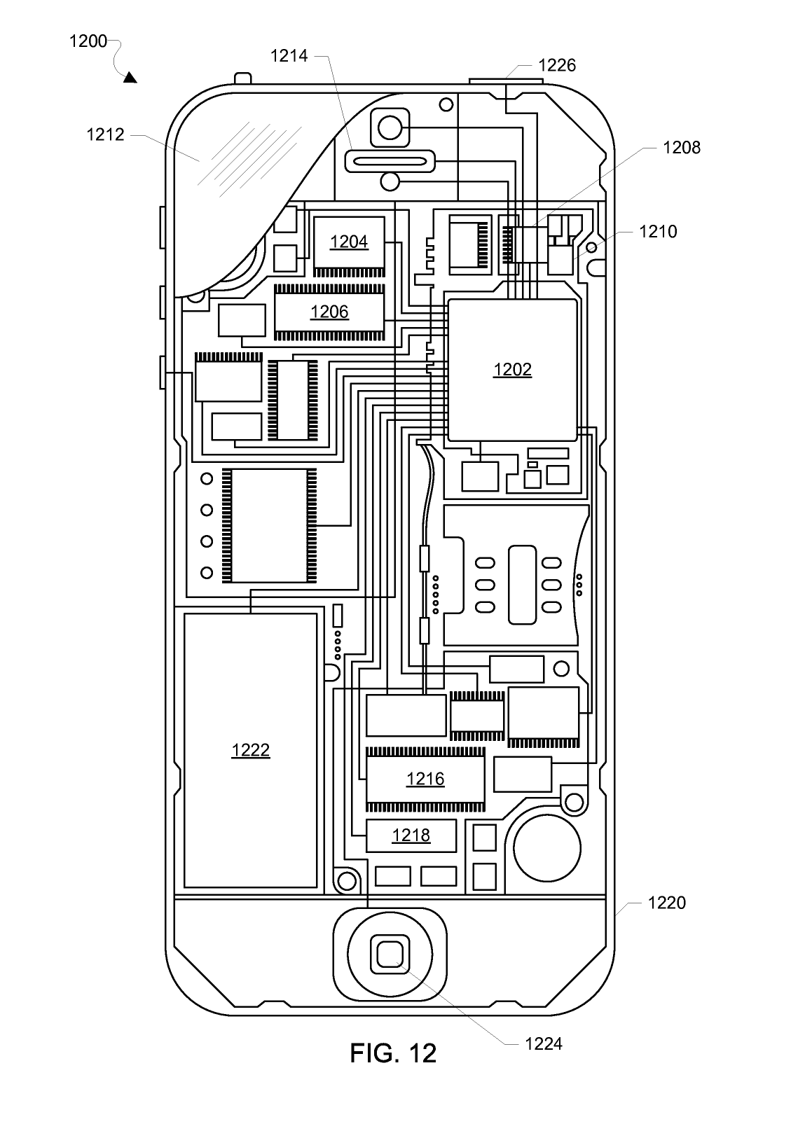

The various aspects (including, but not limited to, aspects discussed above with reference to FIGS. 1-11) may be implemented in a wide variety of computing systems, which may include an example mobile computing device suitable for use with the various aspects illustrated in FIG. 12. The mobile computing device 1200 may include a processor 1202 coupled to a touchscreen controller 1204 and an internal memory 1206. The processor 1202 may be one or more multicore integrated circuits designated for general or specific processing tasks. The internal memory 1206 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1204 and the processor 1202 may also be coupled to a touchscreen panel 1212, such as a resistive-sensing touchscreen, capacitive-sensing touchscreen, infrared sensing touchscreen, etc. Additionally, the display of the computing device 1200 need not have touch screen capability.

The mobile computing device 1200 may have one or more radio signal transceivers 1208 (e.g., Peanut, Bluetooth, Zigbee, Wi-Fi, RF radio) and antennae 1210, for sending and receiving communications, coupled to each other and/or to the processor 1202. The transceivers 1208 and antennae 1210 may be used with the above-mentioned circuitry to implement the various wireless transmission protocol stacks and interfaces. The mobile computing device 1200 may include a cellular network wireless modem chip 1216 that enables communication via a cellular network and is coupled to the processor.

The mobile computing device 1200 may include a peripheral device connection interface 1218 coupled to the processor 1202. The peripheral device connection interface 1218 may be singularly configured to accept one type of connection, or may be configured to accept various types of physical and communication connections, common or proprietary, such as USB, FireWire, Thunderbolt, or PCIe. The peripheral device connection interface 1218 may also be coupled to a similarly configured peripheral device connection port (not shown).

The mobile computing device 1200 may also include speakers 1214 for providing audio outputs. The mobile computing device 1200 may also include a housing 1220, constructed of a plastic, metal, or a combination of materials, for containing all or some of the components discussed herein. The mobile computing device 1200 may include a power source 1222 coupled to the processor 1202, such as a disposable or rechargeable battery. The rechargeable battery may also be coupled to the peripheral device connection port to receive a charging current from a source external to the mobile computing device 1200. The mobile computing device 1200 may also include a physical button 1224 for receiving user inputs. The mobile computing device 1200 may also include a power button 1226 for turning the mobile computing device 1200 on and off.

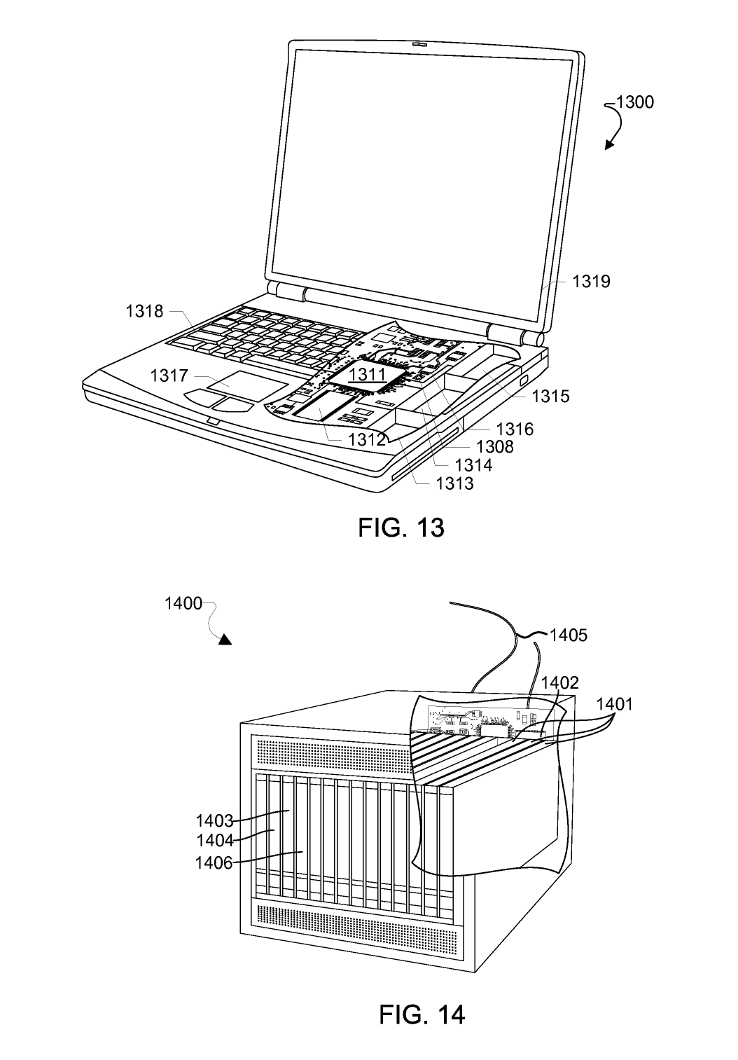

The various aspects (including, but not limited to, aspects discussed above with reference to FIGS. 1-11) may be implemented in a wide variety of computing systems, which may include a variety of mobile computing devices, such as a laptop computer 1300 illustrated in FIG. 13. Many laptop computers include a touchpad touch surface 1317 that serves as the computer's pointing device, and thus may receive drag, scroll, and flick gestures similar to those implemented on computing devices equipped with a touch screen display and described above. A laptop computer 1300 will typically include a processor 1311 coupled to volatile memory 1312 and a large capacity nonvolatile memory, such as a disk drive 1313 of Flash memory. Additionally, the computer 1300 may have one or more antenna 1308 for sending and receiving electromagnetic radiation that may be connected to a wireless data link and/or cellular telephone transceiver 1316 coupled to the processor 1311. The computer 1300 may also include a floppy disc drive 1314 and a compact disc (CD) drive 1315 coupled to the processor 1311. In a notebook configuration, the computer housing includes the touchpad 1317, the keyboard 1318, and the display 1319 all coupled to the processor 1311. Other configurations of the computing device may include a computer mouse or trackball coupled to the processor (e.g., via a USB input) as are well known, which may also be used in conjunction with the various aspects.

The various aspects (including, but not limited to, aspects discussed above with reference to FIGS. 1-11) may be implemented in a wide variety of computing systems, which may include any of a variety of commercially available servers for compressing data in server cache memory. An example server 1400 is illustrated in FIG. 14. Such a server 1400 typically includes one or more multi-core processor assemblies 1401 coupled to volatile memory 1402 and a large capacity nonvolatile memory, such as a disk drive 1404. As illustrated in FIG. 14, multi-core processor assemblies 1401 may be added to the server 1400 by inserting them into the racks of the assembly. The server 1400 may also include a floppy disc drive, compact disc (CD) or DVD disc drive 1406 coupled to the processor 1401. The server 1400 may also include network access ports 1403 coupled to the multi-core processor assemblies 1401 for establishing network interface connections with a network 1405, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Many computing devices operating system kernels are organized into a user space (where non-privileged code runs) and a kernel space (where privileged code runs). This separation is of particular importance in Android and other general public license (GPL) environments in which code that is part of the kernel space must be GPL licensed, while code running in the user-space may not be GPL licensed. It should be understood that the various software components/modules discussed here may be implemented in either the kernel space or the user space, unless expressly stated otherwise.

The foregoing method descriptions and the process flow diagrams are provided merely as illustrative examples and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various aspects may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method of detecting return oriented programming attacks on a computing device, comprising:
loading a memory traversal map for a program called to run on the computing device;
monitoring a memory access request of the program to a memory of the computing device;
comparing a memory address of the memory from the memory access request to the memory traversal map; and
determining whether the memory access request indicates a return oriented programming attack based on comparing the memory address to the memory traversal map.

2. The method of claim 1, wherein the memory traversal map comprises a plurality of memory addresses for processor-executable codes of the program stored in the memory and the plurality of memory addresses are linked in an order of access of the memory corresponding to an order of execution of the processor-executable codes for the program such that a next memory address of the plurality of memory addresses is adjacent to a previous memory address in the memory traversal map.

3. The method of claim 2, wherein:
loading a memory traversal map for a program running on the computing device comprises loading the next memory address based on a previous memory access request for the previous memory address; and
comparing a memory address of the memory from the memory access request to the memory traversal map comprises comparing the memory address to the next memory address.

4. The method of claim 2, wherein:
comparing a memory address of the memory from the memory access request to the memory traversal map comprises determining whether the memory address matches the next memory address; and
determining whether the memory access request indicates a return oriented programming attack based on comparing the memory address to the memory traversal map comprises determining whether the memory access request indicates a return oriented programming attack in response to determining that the memory address does not match the next memory address.

5. The method of claim 1, further comprising:
holding a return of the memory access request in response to determining that the memory access request indicates a return oriented programming attack; and
releasing the return of the memory access request in response to determining that the memory access request does not indicate a return oriented programming attack.

6. The method of claim 1, further comprising:
determining an anomaly score for a mismatch between the memory address of the memory from the memory access request and the memory traversal map;
calculating a cumulative anomaly score using the determined anomaly score;
comparing the cumulative anomaly score to a cumulative anomaly score threshold; and
loading a finer grain memory traversal map in response to the cumulative anomaly score exceeding the cumulative anomaly score threshold.

7. The method of claim 1, wherein loading a memory traversal map for a program called to run on the computing device comprises loading a memory traversal map representing a part of the program likely to be affected by a return oriented programming attack.

8. The method of claim 1, further comprising triggering a configurable security response in response to determining that the memory access request indicates a return oriented programming attack.

9. The method of claim 1, wherein the memory traversal map is a virtual memory traversal map created from an interprocedural control flow graph and a virtual memory layout of the program.

10. The method of claim 1, wherein the memory traversal map is a physical memory traversal map created from an interprocedural control flow graph, a virtual memory layout of the program, and an operating system virtual-to-physical page map.

11. A computing device, comprising:
a memory; and
a processor coupled to the memory and configured with processor-executable to perform operations comprising:
loading a memory traversal map for a program called to run on the processor;
monitoring a memory access request of the program to the memory;
comparing a memory address of the memory from the memory access request to the memory traversal map; and
determining whether the memory access request indicates a return oriented programming attack based on comparing the memory address to the memory traversal map.

12. The computing device of claim 11, wherein the memory traversal map comprises a plurality of memory addresses for processor-executable codes of the program stored in the memory and the plurality of memory addresses are linked in an order of access of the memory corresponding to an order of execution of the processor-executable codes for the program such that a next memory address of the plurality of memory addresses is adjacent to a previous memory address in the memory traversal map.

13. The method of claim 2, wherein the processor is configured with processor-executable to perform operations comprising:
loading a memory traversal map for a program running on the processor comprises loading the next memory address based on a previous memory access request for the previous memory address; and
comparing a memory address of the memory from the memory access request to the memory traversal map comprises comparing the memory address to the next memory address.

14. The method of claim 2, wherein the processor is configured with processor-executable to perform operations such that:
comparing a memory address of the memory from the memory access request to the memory traversal map comprises determining whether the memory address matches the next memory address; and
determining whether the memory access request indicates a return oriented programming attack based on comparing the memory address to the memory traversal map comprises determining whether the memory access request indicates a return oriented programming attack in response to determining that the memory address does not match the next memory address.

15. The computing device of claim 11, the processor is configured with processor-executable to perform operations further comprising:
holding a return of the memory access request in response to determining that the memory access request indicates a return oriented programming attack; and
releasing the return of the memory access request in response to determining that the memory access request does not indicate a return oriented programming attack.

16. The computing device of claim 11, the processor is configured with processor-executable to perform operations further comprising:
determining an anomaly score for a mismatch between the memory address of the memory from the memory access request and the memory traversal map;
calculating a cumulative anomaly score using the determined anomaly score;
comparing the cumulative anomaly score to a cumulative anomaly score threshold; and
loading a finer grain memory traversal map in response to the cumulative anomaly score exceeding the cumulative anomaly score threshold.

17. The computing device of claim 11, wherein the processor is configured with processor-executable to perform operations such that loading a memory traversal map for a program called to run on the processor comprises loading a memory traversal map representing a part of the program likely to be affected by a return oriented programming attack.

18. The computing device of claim 11, the processor is configured with processor-executable to perform operations further comprising triggering a configurable security response in response to determining that the memory access request indicates a return oriented programming attack.

19. The computing device of claim 11, wherein the processor is configured with processor-executable to perform operations comprising creating the memory traversal map as a virtual memory traversal map from an interprocedural control flow graph and a virtual memory layout of the program.

20. The computing device of claim 11, wherein the processor is configured with processor-executable to perform operations comprising creating the memory traversal map as a physical memory traversal map from an interprocedural control flow graph, a virtual memory layout of the program, and an operating system virtual-to-physical page map.

21. A computing device, comprising:
means for loading a memory traversal map for a program called to run on the computing device;
means for monitoring a memory access request of the program to a memory of the computing device;
means for comparing a memory address of the memory from the memory access request to the memory traversal map; and
means for determining whether the memory access request indicates a return oriented programming attack based comparing the memory address to the memory traversal map.

22. The computing device of claim 21, wherein the memory traversal map comprises a plurality of memory addresses for processor-executable codes of the program stored in the memory and the plurality of memory addresses are linked in an order of access of the memory corresponding to an order of execution of the processor-executable codes for the program such that a next memory address of the plurality of memory addresses is adjacent to a previous memory address in the memory traversal map.

23. The computing device of claim 22, wherein:
means for loading a memory traversal map for a program running on the computing device comprises loading the next memory address based on a previous memory access request for the previous memory address; and
means for comparing a memory address of the memory from the memory access request to the memory traversal map comprises comparing the memory address to the next memory address.

24. The computing device of claim 22, wherein:
means for comparing a memory address of the memory from the memory access request to the memory traversal map comprises means for determining whether the memory address matches the next memory address; and
means for determining whether the memory access request indicates a return oriented programming attack based on comparing the memory address to the memory traversal map comprises means for determining whether the memory access request indicates a return oriented programming attack in response to determining that the memory address does not match the next memory address.

25. The computing device of claim 22, further comprising:
means for holding a return of the memory access request in response to determining that the memory access request indicates a return oriented programming attack; and
means for releasing the return of the memory access request in response to determining that the memory access request does not indicate a return oriented programming attack.

26. The computing device of claim 22, further comprising:
means for determining an anomaly score for a mismatch between the memory address of the memory from the memory access request and the memory traversal map;
means for calculating a cumulative anomaly score using the determined anomaly score;
means for comparing the cumulative anomaly score to a cumulative anomaly score threshold; and
means for loading a finer grain memory traversal map in response to the cumulative anomaly score exceeding the cumulative anomaly score threshold.

27. The computing device of claim 22, wherein means for loading a memory traversal map for a program called to run on the computing device comprises means for loading a memory traversal map representing a part of the program likely to be affected by a return oriented programming attack.

28. The computing device of claim 22, further comprising means for triggering a configurable security response in response to determining that the memory access request indicates a return oriented programming attack.

29. The computing device of claim 22, further comprising means for creating the memory traversal map as a virtual memory traversal map from an interprocedural control flow graph and a virtual memory layout of the program.

30. The computing device of claim 22, further comprising means for creating the memory traversal map as a physical memory traversal map from an interprocedural control flow graph, a virtual memory layout of the program, and an operating system virtual-to-physical page map.

31. A non-transitory processor-readable storage medium having stored thereon processor-executable instructions configured to cause a processor of a computing device to perform operations comprising:
loading a memory traversal map for a program called to run on the computing device;
monitoring a memory access request of the program to a memory of the computing device;
comparing a memory address of the memory from the memory access request to the memory traversal map; and
determining whether the memory access request indicates a return oriented programming attack based on comparing the memory address to the memory traversal map.

32. The non-transitory processor-readable storage medium of claim 31, wherein the memory traversal map comprises a plurality of memory addresses for processor-executable codes of the program stored in the memory and the plurality of memory addresses are linked in an order of access of the memory corresponding to an order of execution of the processor-executable codes for the program such that a next memory address of the plurality of memory addresses is adjacent to a previous memory address in the memory traversal map.

33. The non-transitory processor-readable storage medium of claim 32, wherein the stored processor-executable instructions are configured to cause the processor to perform operations such that:
loading a memory traversal map for a program running on the computing device comprises loading the next memory address based on a previous memory access request for the previous memory address; and
comparing a memory address of the memory from the memory access request to the memory traversal map comprises comparing the memory address to the next memory address.

34. The non-transitory processor-readable storage medium of claim 32, wherein the stored processor-executable instructions are configured to cause the processor to perform operations such that:
comparing a memory address of the memory from the memory access request to the memory traversal map comprises determining whether the memory address matches the next memory address; and
determining whether the memory access request indicates a return oriented programming attack based on comparing the memory address to the memory traversal map comprises determining whether the memory access request indicates a return oriented programming attack in response to determining that the memory address does not match the next memory address.

35. The non-transitory processor-readable storage medium of claim 32, wherein the stored processor-executable instructions are configured to cause the processor to perform operations further comprising:
holding a return of the memory access request in response to determining that the memory access request indicates a return oriented programming attack; and
releasing the return of the memory access request in response to determining that the memory access request does not indicate a return oriented programming attack.

36. The non-transitory processor-readable storage medium of claim 32, wherein the stored processor-executable instructions are configured to cause the processor to perform operations further comprising:
determining an anomaly score for a mismatch between the memory address of the memory from the memory access request and the memory traversal map;
calculating a cumulative anomaly score using the determined anomaly score;
comparing the cumulative anomaly score to a cumulative anomaly score threshold; and
loading a finer grain memory traversal map in response to the cumulative anomaly score exceeding the cumulative anomaly score threshold.

37. The non-transitory processor-readable storage medium of claim 32, wherein the stored processor-executable instructions are configured to cause the processor to perform operations such that loading a memory traversal map for a program called to run on the computing device comprises loading a memory traversal map representing a part of the program likely to be affected by a return oriented programming attack.

38. The non-transitory processor-readable storage medium of claim 32, wherein the stored processor-executable instructions are configured to cause the processor to perform operations further comprising triggering a configurable security response in response to determining that the memory access request indicates a return oriented programming attack.

39. The non-transitory processor-readable storage medium of claim 32, wherein the stored processor-executable instructions are configured to cause the processor to perform operations further comprising creating the memory traversal map as a virtual memory traversal map from an interprocedural control flow graph and a virtual memory layout of the program.

40. The non-transitory processor-readable storage medium of claim 32, wherein the stored processor-executable instructions are configured to cause the processor to perform operations further comprising creating the memory traversal map as a physical memory traversal map from an interprocedural control flow graph, a virtual memory layout of the program, and an operating system virtual-to-physical page map.
